(19) United States
(12) Patent Application Publication
(10) Pub. No.: US 2020/0366097 A1
(43) Pub. Date: Nov. 19, 2020

(54) Control Of Photovoltaic Systems

(71) Applicant: Siemens Schweiz AG, Zürich (CH)

(72) Inventor: Conrad Gähler, Zürich (CH)

(73) Assignee: Siemens Schweiz AG, Zürich (CH)

(21) Appl. No.: 15/930,027

(22) Filed: May 12, 2020

(30) Foreign Application Priority Data
May 13, 2019 (EP) 19174050.5

(51) Int. Cl. H02J 3/38; G05B 13/04; H02J 13/00; H02J 3/00

(52) U.S. Cl. CPC H02J 3/381; G05B 13/048; H02S 10/12; H02J 13/00002; H02J 3/004; H02J 13/00006

(57) ABSTRACT

A power system comprises: an energy conversion module; a power meter; a switch; a system controller; and a power transmission bus from the energy conversion module to the switch. The switch connects the bus to a load in response to a load connection signal. The power meter records amounts of power being transmitted along the power transmission bus. The system controller: reads a first and a second time series each having a plurality of power signals indicating power recorded by the meter; determines a maximum series by applying a maximum function to one of the first power signals and one of the second power signals; determines a forecast series from the maximum series; determines the load connection signal from the forecast series; and communicates the load connection signal to the switch.

### CROSS-REFERENCE TO RELATED APPLICATIONS

This application claims priority to EP Patent Application No. 19174050.5, filed on May 13, 2019. The contents of the aforesaid application are incorporated herein for all purposes.

### TECHNICAL FIELD

The present disclosure relates to power systems. Various embodiments of the teachings herein include optimizations for power systems such as rooftop photovoltaic systems and/or improved forecasts of electric power supplied by such installations.

### BACKGROUND

A plethora of parameters influence the amounts of power supplied by a photovoltaic installation. These parameters include, but are not limited to: geographical latitude, inverter efficiency, nearby obstacles such as nearby buildings, seasonal influences such as foliage, etc. Parameters of a photovoltaic system such as inverter efficiency and geographical latitude may be configured during installation or commissioning. The system may then use a complex mathematical model to forecast its power output throughout the day.

Patent application WO2012/122234A2 deals with systems and methods for optimizing energy and resource management for building systems. The optimizations of WO2012/122234A2 accommodate for onsite energy supply 310 as well as for onsite energy storage 312. An electrical model load model 306 as well as an electrical demand model 308 is generated based on subsystem measurements. These subsystem measurements pertain to sensor or equipment readings such as lighting readings within a room or within a group of rooms. Also, historical data such as temperature, humidity, carbon dioxide, air flow, weather conditions etc. may be factored in.

European patent application EP2903217A1 describes a building automation method and a system. The method of EP2903217A1 comprises a step of averaging (4) data time histories. These data time histories are acquired from an input device such as a power meter, a water meter, an internet router, a temperature sensor, a light sensor etc. In addition, automated processes such as watering plants and/or telephones switching to sleep mode may be filtered (3) out of the data time history.

European patent application EP2911018A1 describes a building automation system that uses a predictive model. EP2911018A1 discloses an approach wherein a reading is acquired from an input device such as a power meter, a water meter, an internet router, a temperature sensor, a light sensor etc. The reading is then used as an input of a predictive model (3). An output value of the predictive model (3) is then compared to a measured value (1) and causes of such deviations are identified (7).

### SUMMARY

The teachings of the present disclosure include a power system that minimizes the effort during installation and commissioning. The system largely dispenses with configuration data. Also, the system avoids use of complex mathematical relationships between parameters of an installation and the power output of an installation. As an example, some embodiments include a power system (1) comprising: at least one energy conversion module (2a, 2b, 2c), a power meter (4), a switch (5), a system controller (7), a power transmission bus (9a, 9b) extending from the at least one energy conversion module (2a, 2b, 2c) to the switch (5); wherein the switch (5) is configured to connect the power transmission bus (9a, 9b) to a load (6) in response to receiving a load connection signal; wherein the power meter (4) connects to the power transmission bus (9a, 9b) and is configured to record amounts of power being transmitted along the power transmission bus (9a, 9b); the system controller (7) being in operative communication with the power meter (4) and with the switch (5) and being configured to: read a first time series having a first plurality of power signals and a second time series having a second plurality of power signals from the power meter (4), each power signal being indicative of an amount of power recorded by the power meter (4); determine from the first and from the second time series a maximum series having a plurality of entries, wherein at least one entry is determined by applying a maximum function to a power signal of the first plurality of power signals and to a power signal of the second plurality of power signals; determine a forecast series from the plurality of entries of the maximum series; determine the load connection signal from the forecast series; and communicate the load connection signal to the switch (5).

In some embodiments, the system controller (7) comprises a memory, the memory storing a threshold quantity, the system controller (7) being configured to: read the threshold quantity from the memory; calculate a quantity from the forecast series, the calculated quantity being selected from: a maximum value of the forecast series, a minimum value of the forecast series, a median value of the forecast series, an average value of the forecast series, compare the calculated quantity to the threshold quantity; determine the load connection signal from the forecast series based on the comparison; and communicate the load connection signal to the switch (5).

In some embodiments, the switch (5) is configured to connect the power transmission bus (9a, 9b) to a load (6) and to disconnect the power transmission bus (9a, 9b) from the load (6); and wherein the power system (1) comprises a power conversion module (3) situated in the power transmission bus (9a, 9b), the power conversion module (3) being configured to convert electric power originating from the at least one energy conversion module (2a, 2b, 2c) into electric power suitable for the load (6).

In some embodiments, the power meter (4) comprises the system controller (7).

In some embodiments, the system controller (7) is configured to: read a plurality of time series from the power meter (4), wherein each time series has a plurality of power signals, each power signal being indicative of an amount of power recorded by the power meter (4); determine from the plurality of time series an indexed series, the indexed series comprising at least one power signal from each time series; and determine from the plurality of time series a maximum series having a plurality of entries, wherein at least one entry of the maximum series is a maximum value of the indexed series.

In some embodiments, the system controller (7) is configured to: read a plurality of time series from the power meter (4), wherein each time series has a plurality of power signals, each power signal being indicative of an amount of power recorded by the power meter (4); determine from the plurality of time series a plurality of indexed series, every indexed series comprising at least one power signal from each time series; and determine from the plurality of indexed series a maximum series having a plurality of entries, wherein every entry of the maximum series is a maximum value of one indexed series of the plurality of indexed series.

In some embodiments, the system controller (7) is configured to: receive a weather forecast signal; and determine the forecast series as a function of the plurality of entries of the maximum series and as a function of the weather forecast signal.

In some embodiments, the system controller (7) is configured to: determine the forecast series as a function of the plurality of entries of the maximum series by modifying at least one entry of the maximum series as a function of the weather forecast signal.

In some embodiments, the system controller (7) is configured to: determine the forecast series as a function of the plurality of entries of the maximum series by modifying every entry of the maximum series as a function of the weather forecast signal.

In some embodiments, the power system (1) comprises a temperature sensor (12); and wherein the system controller (7) is in operative communication with the temperature sensor (12) and is configured to: read a temperature signal from the temperature sensor (12); and determine the forecast series as a function of the plurality of entries of the maximum series and as a function of the temperature signal.

In some embodiments, the system controller (7) is configured to:

determine the forecast series as a function of the plurality of entries of the maximum series by modifying at least one entry of the maximum series as a function of the temperature signal.

In some embodiments, the system controller (7) is configured to: determine the forecast series as a function of the plurality of entries of the maximum series by modifying every entry of the maximum series as a function of the temperature signal.

In some embodiments, the system controller (7) is configured to: communicate the forecast series to a remote controller (8) using a digital communication protocol, the remote controller (8) being located remotely from the power system (1).

In some embodiments, there is method for controlling a power system (1), the power system (1) comprising a power meter (4), the method comprising the steps of: receiving a weather forecast signal; reading a plurality of time series from the power meter (4), wherein each time series has a plurality of power signals, each power signal being indicative of an amount of power recorded by the power meter (4); determining from the plurality of time series a plurality of indexed series, every indexed series comprising at least one power signal from each time series; determining from the plurality of time series a maximum series having a plurality of entries, wherein at least one entry of the maximum series is a maximum value of one indexed series of the plurality of indexed series; determining a forecast series by modifying every entry of the maximum series as a function of the weather forecast signal; determining a load connection signal from the forecast series; and communicating the load connection signal to a switch (5).

As another example, some embodiments include a non-transitory, computer-readable medium containing a program which executes the steps of the methods described above.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic representation of a power system incorporating teachings of this disclosure.

FIG. 2 schematically illustrates details of a connection to a cloud service incorporating teachings of this disclosure.

FIG. 3 schematically provides details of a power system installed on top of a building incorporating teachings of this disclosure.

### DETAILED DESCRIPTION

The present disclosure describes a power system that functions to forecast local energy conversion such as energy conversion by solar panels or wind turbines. The forecast amounts of power may then be used to make or break a connection between the power system and a load. The forecast amounts of power may also be used to switch variable loads connected to the power system and/or to the load. That is, variable loads can be enabled or disabled depending on availability of power from the power system.

Some embodiments include a power system that can be adapted to various voltage levels and to various power frequencies of a load. Some embodiments include a power system that is compact and to minimize the numbers of components that are prone to failure. Some embodiments include a power system operable to produce forecasts of supplied power, wherein the forecast is based on a statistical analysis of time histories of amounts of power supplied by the power system. Some embodiments include a power system operable to produce forecasts of supplied power, wherein weather forecasts such as local weather forecasts are factored in when forecasting power supply. Some embodiments include a power system operable to produce forecasts of supplied power, wherein temperatures such as local temperatures outside a building are factored in when forecasting power supply. Some embodiments include a power system operable to make a forecast of power supply available at a cloud service and/or at a load operator. Some embodiments include a power system wherein an operator can set criteria applicable to load connection and/or load disconnection. It is still another object of the instant disclosure to provide a power system wherein an operator can set criteria applicable to control of variable loads such as washing machines, dryers, electric vehicles to be charged, etc. Some embodiments include a power system that makes full use of the digital communication capabilities of a controller of the power system.

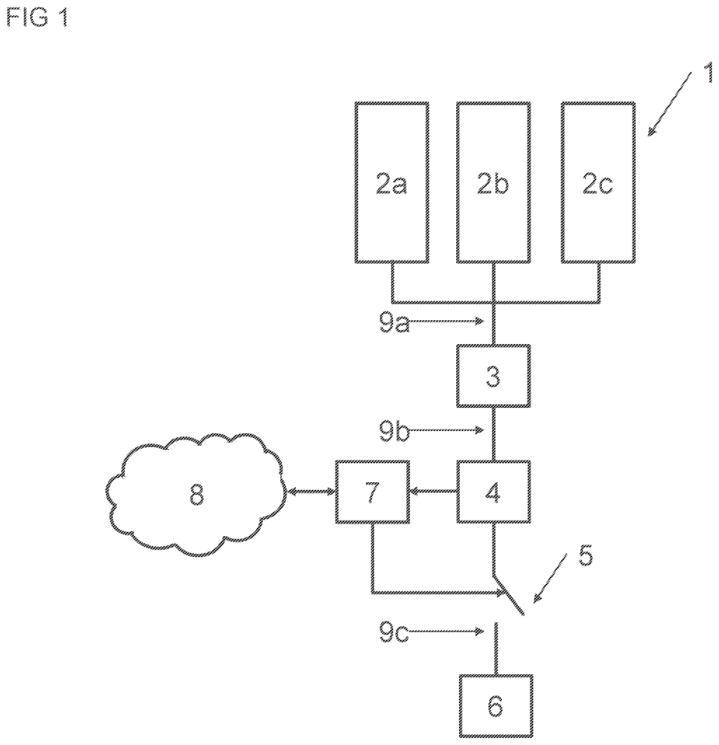

FIG. 1 shows various components of a power system 1 incorporating teachings of the present disclosure. The power system 1 as shown comprises a photovoltaic system and/or a photovoltaic installation and/or a wind turbine system and/or a wind turbine installation and/or a wind farm system and/or a wind farm installation. The power system 1 comprises at least one energy conversion module 2a-2c such as a solar panel or a wind turbine. In some embodiments, the power system 1 comprises different types of energy conversion modules 2a-2c being lumped together. The power system 1 may, by way of non-limiting example, comprise a solar panel 2a, a wind turbine 2b, and a geothermal unit 2c.

The power system 1 also comprises a power conversion module 3 such as an inverter and/or a power transformer. An installation with one or more solar panels 2a-2c can rely on an inverter 3. The inverter 3 produces an alternating current from a direct current originating from the one or more solar panels 2a-2c. It is envisaged that the inverter produces an alternating current having a frequency of or near 50 Hertz and/or of or near 60 Hertz and/or of or near 400 Hertz. The inverter advantageously produces an alternating current that is synchronous to an alternating current of a load. The inverter 3 can also transform the output voltage of the one or more solar panels 2a-2c into a load voltage. To that end, the inverter 3 can comprise several stages. It is envisaged that the inverter produces a load voltage of 110 Volts and/or of 190 Volts and/or of 240 Volts and/or of 420 Volts.

An installation with one or more wind turbines can rely on a power transformer 3. The power transformer 3 transforms the output voltage of the one or more wind turbines 2a-2c into a load voltage. To that end, the power transformer 3 comprises a plurality of windings. The power transformer 3 advantageously comprises a tap changer to control the ratio of the power transformer 3. It is envisaged that the power transformer produces a load voltage of 4 kiloVolts phase-to-phase and/or of 11 kiloVolts phase-to-phase and/or of 35 kiloVolts phase-to-phase voltage.

A power meter 4 of the power system affords measurements of amounts of power. The power meter 4 can be a power meter 4 with sufficient accuracy such that the power meter 4 can be used for billing. The power meter 4 can also be a power meter designed for protection purposes. In some embodiments, the power meter 4 comprises one or more current transformers for billing and/or for protection purposes.

A switch 5 connects the power system 1 to a load 6. The switch 5 is operable to connect the power system 1 to the load 6. It is envisaged that the switch 5 comprises a mechanical switch with a pair of contacts. The switch 5 then connects the power system 1 to the load 6 by closing its contacts. The switch 5 can, by way of non-limiting example, comprise a self-blast circuit breaker and/or a thermal buffer circuit breaker and/or a vacuum circuit breaker. In some embodiments, the switch 5 is part of a gas-insulated switchgear installation. In some embodiments, the switch 5 comprises a semi-conductor switch such as a thyristor and/or an insulated-gate bipolar transistor (IGBT). In this case, the switch 5 makes the connection to the load 6 by controlling the voltage applied to the gate terminal of the semiconducting switch.

The switch 5 is also operable to break the connection to the power system 1 from the load 6. In some embodiments, the switch 5 comprises a mechanical switch with a pair of contacts. The switch 5 then breaks the connection to the load 6 by opening its contacts. The switch 5 can, by way of non-limiting embodiment, comprise a self-blast circuit breaker and/or a thermal buffer circuit breaker and/or a vacuum circuit breaker. In some embodiments, the switch is part of a gas-insulated switchgear installation. In some embodiments, the switch 5 comprises a semi-conductor switch such as an insulated-gate bipolar transistor (IGBT). In that case, the switch 5 breaks the connection to the load 6 by controlling the voltage applied to the gate terminal of the IGBT.

FIG. 1 shows the power meter 4 situated between the power conversion module 3 and the switch 5. The skilled person understands that the meter 4 can also be situated between the energy conversion module(s) 2a-2c and the power conversion module 3. The load 6 can be a load 6 of a building. In this case, the load 6 is a single-phase load and/or a three-phase load. Typical voltages of the load 6 are 110 Volts (phase-to-earth) and/or 240 Volts (phase-to-earth) and/or 420 Volts (phase-to-phase). The load 6 typically provides electric currents of up to 10 Amperes and/or 16 Amperes and/or 25 Amperes.

The load 6 can be a load 6 of a power distribution network. In this case, the load 6 typically is a three-phase load or a six-phase load. Typical voltages of the load 6 are 4 kiloVolts (phase-to-phase) and/or 11 kiloVolts (phase-to-phase) and/or 35 kiloVolts (phase-to-phase).

A system controller 7 is in operative communication with the power meter 4. To that end, the system controller 7 can read digital and/or analog signals from the power meter 4. In some embodiments, the controller 7 samples analog signals between 0 milliAmpere and 20 milliAmperes and/or between 0 Volt and 3.3 Volts and/or between 0 Volt and 5 Volts. In some embodiments, the digital communication bus connects the system controller 7 to the power meter 4. In some embodiments, the digital communication bus allows for bidirectional communication between the controller 7 and the power meter 4. In some embodiments, the digital communication bus enables exchange of data packets between the system controller 7 and the power meter 4 in accordance with a digital communication protocol. In some embodiments, the digital communication protocol can be a protocol as defined in an IEC 61850 standard.

In some embodiments, the system controller 7 can comprise a microprocessor and/or a microcontroller. In some embodiments, the system controller 7 is based on, preferably is directly based on, a reduced instruction set architecture. In an alternate embodiment, the system controller 7 is based on, preferably is directly based on, a complex instruction set architecture. The system controller 7 advantageously comprises a memory and at least one arithmetic logic unit.

The arithmetic logic unit of the system controller 7 is in operative communication with the memory of the system controller 7. That way, data can be written to the memory and can be read from the memory. In some embodiments, the system controller 7, the arithmetic logic unit and the memory are arranged on the same chip, e.g. on the same system on a chip (SoC).

In some embodiments, the system controller 7 and the power meter 4 form a single device. That is, the system controller 7 is lumped together with the (main components of the) power meter 4 in a single housing. The system controller 7 can, for instance, be installed in a single housing together with various current transformers of the power meter 4.

In some embodiments, the system controller 7 has an operating system. The operating system can comprise a Windows® operating system and/or a Linux® operating system such as a Raspbian system. The skilled person also considers systems that have been tailored for use in embedded systems. A general-purpose system can also be employed as an operating system of the system controller 7.

In some embodiments, the local computing capacity and/or the local storage capacity of the system controller 7 can be limited. That is why the system controller 7 ideally provides connectivity to connect the system controller 7 to one or more remote controllers 8. In some embodiments, the connection between the system controller 7 the remote controller 8 employs a transmission control protocol/internet protocol (TCP/IP) connection. In some embodiments, traffic along that connection follows a connectionless protocol. The connection may also employ a user datagram protocol (UDP) connection.

In some embodiments, the remote controller 8 comprises a cloud computer and/or a cloud computing arrangement. The remote controller 8 can actually comprise a plurality of controllers arranged in a plurality of data centres. The remote controller 8 is typically located remotely from the power system 1.

A suitable wireless or hard-wired bus is employed to connect the system controller 7 and to the remote controller 8. The system controller 7 can, for instance, connect to a remote controller such as a cloud server 8 via wireless local area network (WLAN) and/or via a Zigbee® wireless connection and/or via a telephony (global systems for mobile communications, GSM) network and/or via a proprietary wireless technique. In some embodiments, a concrete wall with high attenuation of radio frequency signals may hinder communication between the system controller 7 and the remote controller 8. In order to overcome issues due to noise and/or attenuation, the system controller 7 and/or remote controller 8 may harness techniques such as phase-shift keying and/or redundant datagram packets of limited size.

Data traffic via the connection between the system controller 7 and the remote computer 8 may be encrypted. In some embodiments, a Diffie-Hellman key exchange is employed to encrypt traffic. In some embodiments, the Diffie-Hellman key exchange involves elliptic curves.

The power system 1 also comprises a power transmission bus 9a, 9b. The power transmission bus 9a, 9b extends from the one or more energy conversion modules 2a-2c to the load 6. A first stage 9a of the power transmission bus connects the one or more energy conversion modules 2a-2c to the power conversion module 3. In some embodiments, the first stage 9a of the power transmission bus can be a low voltage power transmission bus 9a such as a power transmission bus 9a operating at voltages below 24 Volts, below 12 Volts, or even below 6 Volts. The first stage 9a can be a direct current power transmission bus depending on requirements of the one or more energy conversion modules 2a-2c. A first stage 9a operating at low voltages and using direct currents offers advantages in terms of compatibility with solar panels 2a-2c.

A second stage 9b of the power transmission bus connects the power conversion module to the power meter 4 and/or to the switch 5. In some embodiments, the second stage 9b has a voltage that is higher than the voltage of the first stage 9a. In some embodiments, the second stage 9b has a voltage of 110 Volts phase-to-earth and/or of 190 Volts phase-to-phase and/or of 240 Volts phase-to-earth and/or of 420 Volts phase-to-phase.

In some embodiments, the second stage employs alternating electric currents. In some embodiments, the second stage 9b relies on alternating currents having a frequencies of or near 50 Hertz and/or of or near 60 Hertz and/or of or near 400 Hertz. In some embodiments, the second stage 9b relies on an alternating current that is synchronous to an alternating current of the load 6. The above alternating currents and voltages confer benefits in terms of compatibility with common electric circuits in buildings.

FIG. 1 shows the power meter 4 situated in the second stage 9b. The skilled person understands that the power meter 4 can also be situated in the first stage 9a. A terminal stage 9c connects the switch 5 to the load 6. The terminal stage 9c has got the same voltage and employs the same (alternating) current as the load 6. The voltage of and the (alternating) current employed by the terminal stage 9c are synchronous to the power voltage of and to the current employed by the load 6.

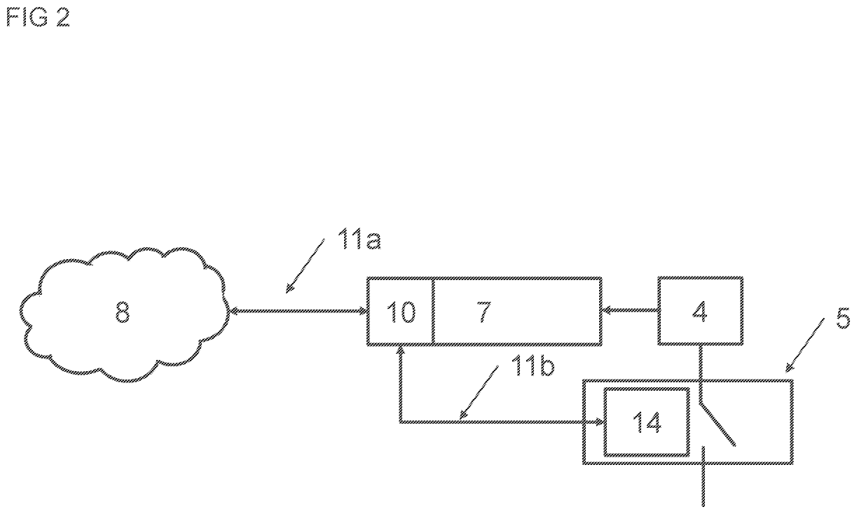

Now referring to FIG. 2, a communication bus 11a is shown that connects the remote controller 8 to an interface 10 of the system controller 7. In some embodiments, the interface 10 of the system controller 7 is a digital communication interface such as a network card and/or a network adapter. In some embodiments, the interface 10 is an integral part of the system controller 7. The interface 10 can, in a special embodiment, be arranged together with a memory and together with an arithmetic logic unit on a single printed circuit board. In some embodiments, the interface 10 of the system controller 7 comprises an Ethernet® port. In some embodiments, the communication bus 11a and the interface 10 afford bidirectional communication between the system controller 7 and the remote controller 8.

The interface 10 is also operable to connect the system controller 7 to the switch 5. To that end, the switch 5 provides a (digital) communication interface 14. The interface 10 of the system controller 7 and the communication interface 14 of the switch 5 can then connect via a communication bus 11b. In some embodiments, the communication bus 11b affords unidirectional communication. Data and/or instructions can thus be sent from the interface 10 of the system controller 7 to the interface 14 of the switch 5. Unidirectional communication along the communication bus 11b confers advantages in terms of reduced complexity.

In some embodiments, the communication bus 11b affords bidirectional communication. Data and/or instructions can thus be sent from the interface 10 of the system controller 7 to the communication interface 14 of the switch 5 and vice versa. Bidirectional communication along the communication bus 11b confers advantages in terms of more flexible and more nuanced communication. The switch 5 can, for instance, employ a bidirectional bus 11b to forward data about its internal condition to the system controller 7.

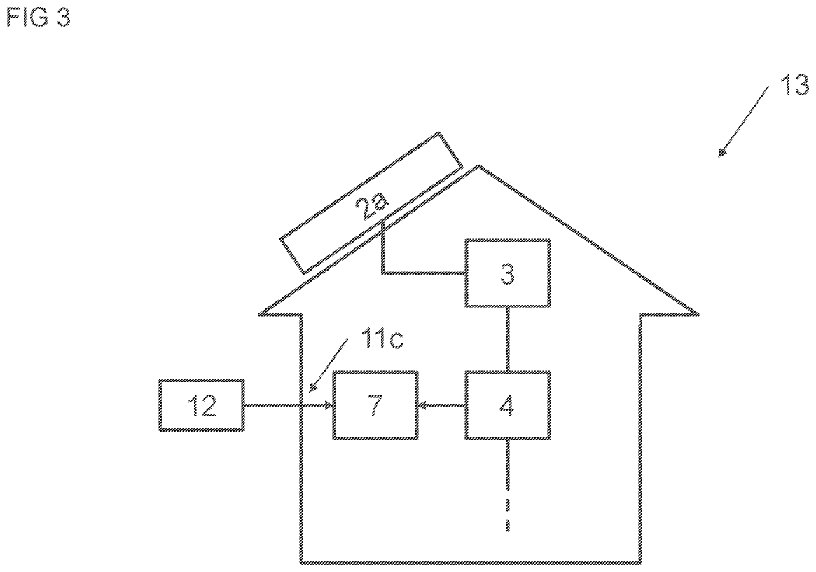

Now turning to FIG. 3, a building 13 with a power system incorporating teachings of the instant disclosure is illustrated. The building 13 can be a commercial, a residential and/or an industrial building. An energy conversion module 2a such as a solar panel can be installed as a rooftop module. The energy conversion module 2a is shown as secured relative to and/or mounted to a roof of the building 1. Whilst the energy conversion module 2a is installed outside the building, the power conversion module 3, the power meter 4, and the system controller 7 may be installed indoors. Indoor installation of such components 3, 4, 7 confers benefits in terms of protection from ambient stresses.

FIG. 2 shows a single interface 10 connecting to the remote controller 8 as well as to the interface 14 of the switch 5. The system controller 7 can also provide separate interfaces that connect to the remote controller 8 and to the interface 14 of the switch 5. FIG. 3 depicts a sensor 12 such as a temperature sensor installed outside the building 13. The temperature sensor 12 is thus arranged to detect and/or to sample temperatures outside the building 13.

The system controller 7 is in operative communication with the temperature sensor 12. To that end, the system controller 7 can read digital and/or analog signals from the temperature sensor 12. In some embodiments, the controller 7 samples analog signals between 0 milliAmpere and 20 milliAmperes and/or between 0 Volt and 3.3 Volts and/or between 0 Volt and 5 Volts. In some embodiments, digital communication bus connects the system controller 7 to the temperature sensor 12.

In some embodiments, the digital communication bus 11c allows for unidirectional communication from the sensor 12 to the system controller 7. Data and/or instructions can then be sent from the temperature sensor 12 to the system controller 7. Unidirectional communication confers advantages in terms of reduced complexity. In some embodiments, the communication bus 101c affords bidirectional communication. Data and/or instructions can thus be sent from the system controller 7 to the sensor 12 and vice versa. Bidirectional communication along the communication bus 11c confers advantages in terms of more flexible and more nuanced communication. In some embodiments, the temperature sensor 12 communicates with the system controller 7 via the communication interface 10.

In some embodiments, a suitable wireless or hard-wired bus can be employed to link the system controller 7 to the temperature sensor 12. The system controller 7 can, for instance, connect to the temperature sensor 12 via wireless local area network (WLAN) and/or via a Zigbee® wireless connection and/or via a telephony (global systems for mobile communications, GSM) network and/or via a proprietary wireless technique. Also, a concrete wall with high attenuation of radio frequency signals may hinder communication between the system controller 7 and the sensor 12. In order to overcome issues due to noise and/or attenuation, the system controller 7 and/or the sensor 12 may harness techniques such as phase-shift keying and/or redundant datagram packets of limited size.

In some embodiments, data traffic via the connection between the system controller 7 and the temperature sensor 12 is encrypted. In some embodiments, a Diffie-Hellman key exchange is employed to encrypt traffic. In some embodiments, the Diffie-Hellman key exchange involves elliptic curves.

In some embodiments, the power system of the instant disclosure is employed in a hospital and/or in a hospital environment.

In some embodiments, a power system (1) comprises:
at least one energy conversion module (2a, 2b, 2c), a power meter (4), a switch (5), a system controller (7), a power transmission bus (9a, 9b) extending from the at least one energy conversion module (2a, 2b, 2c) to the switch (5);
wherein the switch (5) is configured to connect the power transmission bus (9a, 9b) to a load (6) in response to receiving a load connection signal;
wherein the power meter (4) connects to the power transmission bus (9a, 9b) and is configured to record amounts of power being transmitted along the power transmission bus (9a, 9b);
the system controller (7) being in operative communication with the power meter (4) and with the switch (5) and being configured to:
read a first time series having a first plurality of power signals and a second time series having a second plurality of power signals from the power meter (4), each power signal being indicative of an amount of power recorded by the power meter (4);
determine from the first and from the second time series a maximum series having a plurality of entries, wherein at least one entry is determined by applying a maximum function to a power signal of the first plurality of power signals and to a power signal of the second plurality of power signals;
determine a forecast series from the plurality of entries of the maximum series; and
determine the load connection signal from the forecast series; and
communicate the load connection signal to the switch (5).

In some embodiments, the power system (1) comprises a photovoltaic system and/or comprises a photovoltaic installation and/or comprises a wind power plant.

In some embodiments, the load (6) is selected from at least one of:
a battery;
a heat pump;
a generic load.

In some embodiments, the load (6) is selected from at least one of:
a battery;
a heat pump.

In some embodiments, the power transmission bus (9a, 9b) electrically connects to the at least one energy conversion module (2a, 2b, 2c). In some embodiments, the power transmission bus (9a, 9b) is an electric power transmission bus (9a, 9b). In some embodiments, the power transmission bus (9a, 9b) comprises at lest one power transmission line. In some embodiments, the power transmission bus (9a, 9b) is a power transmission line and/or is a power transmitter and/or is a power transmission circuit.

In some embodiments, the power meter (4) is serially connected to the power transmission bus (9a, 9b). In some embodiments, the power signal is a power level signal.

In some embodiments, the digital communication protocol is implemented by the system controller (7). That is, the system controller (7) has a set of instructions to communicate signals in accordance with the digital communication protocol.

In some embodiments, the at least one energy conversion module (2a, 2b, 2c) comprises a solar panel and/or comprises a wind turbine.

A maximum function applied to its arguments and returns its largest argument. That is, a maximum function of 2 and 5 returns 5.

An average function applied to its arguments calculates an average of its arguments. An average function can be selected from an arithmetic average function and/or a geometric average function and/or a first momentum function and/or a second momentum function. It is also envisaged to calculate a median of those arguments.

In some embodiments, the forecast series comprises the maximum series. The forecast series can also be determined from the maximum series by truncating the maximum series. The maximum series in an embodiment is a maximum time series.

In some embodiments, the system controller (7) comprises a memory, the memory storing a threshold quantity, the system controller (7) being configured to:
read the threshold quantity from the memory;
calculate a quantity from the forecast series, the calculated quantity being selected from: a maximum value of the forecast series, a minimum value of the forecast series, a median value of the forecast series, an average value of the forecast series;
compare the calculated quantity to the threshold quantity;
determine the load connection signal from the forecast series based on the comparison; and
communicate the load connection signal to the switch (5).

In some embodiments, the calculated quantity is selected from: a ninety percent quantile of the forecast series, a ninety-five percent quantile of the forecast series, an eighty percent quantile of the forecast series, a fifty percent quantile of the forecast series.

In some embodiments, the switch (5) is configured to connect the power transmission bus (9a, 9b) to a load (6) and to disconnect the power transmission bus (9a, 9b) from the load (6); and
wherein the power system (1) comprises a power conversion module (3) situated in the power transmission bus (9a, 9b), the power conversion module (3) being configured to convert electric power originating from the at least one energy conversion module (2a, 2b, 2c) into electric power suitable for the load (6).

In some embodiments, the power conversion module (3) is a power conditioning module and/or a power conditioning unit. The power conversion module (3) can be serially connected to the power transmission bus (9a, 9b).

In some embodiments, the power meter (4) comprises the system controller (7). The power meter (4) can, in particular, comprise an enclosure and the system controller (7) can be situated inside the enclosure of the power meter (4).

In some embodiments, the power conversion module (3) is secured relative to and/or mounted to the power system (1). In some embodiments, the system controller (7) is secured relative to and/or mounted to the power system (1).

In some embodiments, the system controller (7) is configured to:
read a plurality of time series from the power meter (4), wherein each time series has a plurality of power signals, each power signal being indicative of an amount of power recorded by the power meter (4);
determine from the plurality of time series an indexed series, the indexed series comprising at least one power signal from each time series; and
determine from the plurality of time series a maximum series having a plurality of entries, wherein at least one entry of the maximum series is a maximum value of the indexed series.

In some embodiments, at least one entry of the maximum series is a maximum value of the indexed series.

In some embodiments, the system controller (7) is configured to:
read a plurality of time series from the power meter (4), wherein each time series has a plurality of power signals, each power signal being indicative of an amount of power recorded by the power meter (4);
determine from the plurality of time series a plurality of indexed series, every indexed series comprising at least one power signal from each time series; and
determine from the plurality of indexed series a maximum series having a plurality of entries, wherein every entry of the maximum series is a maximum value of one indexed series of the plurality of indexed series.

In some embodiments, the indexed series correspond to column series of a matrix and that the time series correspond to row series of a matrix. In some embodiments, the forecast series is or comprises the maximum series.

In some embodiments, the system controller (7) is configured to:
receive a weather forecast signal; and
determine the forecast series as a function of the plurality of entries of the maximum series and as a function of the weather forecast signal.

In some embodiments, the weather forecast signal is received by the system controller (7) via a digital communication bus (11a) and using a digital communication bus protocol. In some embodiments, the system controller (7) comprises a digital communication interface (10). That is, the system controller (7) is configured to receive the weather forecast signal via its communication interface (10) and using the digital communication bus protocol. In some embodiments, the system controller (7) is configured to receive the weather forecast signal from the remote controller (8) via the communication interface (10) and using the digital communication bus protocol.

In some embodiments, the remote controller (8) comprises a thermostat such as a smart thermostat. In some embodiments, the remote controller (8) is a thermostat such as a smart thermostat.

In some embodiments, the system controller (7) is configured to: determine the forecast series as a function of the plurality of entries of the maximum series by modifying at least one entry of the maximum series as a function of the weather forecast signal.

In some embodiments, the system controller (7) is configured to:
determine the forecast series as a function of the plurality of entries of the maximum series by modifying every entry of the maximum series as a function of the weather forecast signal.

In some embodiments, the power system (1) comprises a temperature sensor (12); and the system controller (7) is in operative communication with the temperature sensor (12) and is configured to:
read a temperature signal from the temperature sensor (12); and
determine the forecast series as a function of the plurality of entries of the maximum series and as a function of the temperature signal.

In some embodiments, the power system (1) comprises a building (13) and wherein the temperature sensor (12) is installed outside the building (13). The building (13) preferably is or comprises an industrial building and/or a commercial building and/or a residential building.

In some embodiments, the system controller (7) is configured to determine the forecast series as a function of the plurality of entries of the maximum series by modifying at least one entry of the maximum series as a function of the temperature signal.

In some embodiments, the system controller (7) is configured to determine the forecast series as a function of the plurality of entries of the maximum series by modifying every entry of the maximum series as a function of the temperature signal.

In some embodiments, the system controller (7) is configured to communicate the forecast series to a remote controller (8) using a digital communication protocol, the remote controller (8) being located remotely from the power system (1).

In some embodiments, the forecast series is communicated to the remote controller (8) via a digital communication bus (11a) and using a digital communication bus protocol. In some embodiments, the system controller (7) comprises a digital communication interface (10). That is, the system controller (7) is configured to communicate the forecast series to the remote controller (8) via its communication interface (10) and using the digital communication bus protocol.

In some embodiments, the system controller (7) is configured to communicate the load connection signal to the switch (5), the load connection signal causing the switch (5) to connect the power transmission bus (9a, 9b) to the load (6).

In some embodiments, the load connection signal is communicated to the switch (5) via a digital communication bus (11b) and using a digital communication bus protocol. To that end, the power system (1) advantageously comprises the digital communication bus (11b). The bus (11a) connecting the controller (7) to the remote controller (8) can actually be identical to the bus (11b) connecting the controller (7) to the breaker (5). In some embodiments, the system controller (7) comprises a digital communication interface (10). That is, the system controller (7) is configured to communicate the load connection signal to the switch (5) via its communication interface (10) and using the digital communication bus protocol.

In some embodiments, the switch (5) comprises a switch interface (14). That is, the load connection signal is communicated to the switch interface (14) via a digital communication bus (11b) and using a digital communication bus protocol. The switch (5) is configured to connect the power transmission bus (9a, 9b) to the load (6) in response to the switch interface (14) receiving the load connection signal.

In some embodiments, the system controller (7) comprises a memory, the memory storing a threshold quantity, the system controller (7) being configured to:
read the threshold quantity from the memory;
calculate a quantity from the forecast series, the calculated quantity being selected from a maximum value of the forecast series, a minimum value of the forecast series, a median value of the forecast series, an average value of the forecast series;
compare the calculated quantity to the threshold quantity;
determine the load connection signal from the forecast series based on the comparison; and
communicate the load connection signal to the switch (5).

In some embodiments, the system controller (7) is in operative communication with the memory.

In some embodiments, the system controller (7) is configured to determine the load connection signal from the forecast series, if the calculated quantity exceeds the threshold quantity. In some embodiments, the system controller (7) is configured to determine the load connection signal from the forecast series, if the calculated quantity is less than the threshold quantity.

In some embodiments, a method for controlling a power system (1), the power system (1) comprising a power meter (4), comprises the steps of:
receiving a weather forecast signal;
reading a plurality of time series from the power meter (4), wherein each time series has a plurality of power signals, each power signal being indicative of an amount of power recorded by the power meter (4);
determining from the plurality of time series a plurality of indexed series, every indexed series comprising at least one power signal from each time series;
determining from the plurality of time series a maximum series having a plurality of entries, wherein at least one entry of the maximum series is a maximum value of one index series of the plurality of indexed series;
determining a forecast series by modifying every entry of the maximum series as a function of the weather forecast signal;
determining a load connection signal from the forecast series; and
communicating the load connection signal to a switch (5).

Some embodiments include a non-transitory, computer-readable medium containing a program which executes the steps of any of the aforementioned methods. In some embodiments, the computer-readable medium contains instructions that when executed perform the steps and/or perform the method according to the present disclosure. In some embodiments, the computer-readable medium is tangible.

Any steps of a method according to the present disclosure may be embodied in hardware, in a software module executed by a processor, in a software module being executed using operating-system-level virtualization, in a cloud computing arrangement, or in a combination thereof. The software may include a firmware, a hardware driver run in the operating system, or an application program. Thus, the disclosure also relates to a computer program product for performing the operations presented herein. If implemented in software, the functions described may be stored as one or more instructions on a computer-readable medium. Some examples of storage media that may be used include random access memory (RAM), read only memory (ROM), flash memory, EPROM memory, EEPROM memory, registers, a hard disk, a removable disk, other optical disks, or any available media that can be accessed by a computer or any other IT equipment and appliance.

It should be understood that the foregoing relates only to certain embodiments of the teachings of the present disclosure and that numerous changes may be made therein without departing from the scope of the disclosure as defined by the following claims. It should also be understood that the disclosure is not restricted to the illustrated embodiments and that various modifications can be made within the scope of the following claims.

### REFERENCE NUMERALS

1 power system
2a, 2b, 2c energy conversion module
3 power conversion module
4 power meter
5 switch
6 load
7 system controller
8 remote controller
9a, 9b power transmission bus
9c terminal stage
10 interface
11a, 11b communication bus
12 temperature sensor
13 building
14 switch interface

1. A power system comprising:
an energy conversion module;
a power meter;
a switch;
a system controller; and
a power transmission bus extending from the energy conversion module to the switch;
wherein the switch connects the power transmission bus to a load in response to a load connection signal;
the power meter connects to the power transmission bus and records amounts of power being transmitted along the power transmission bus;
the system controller is in operative communication with the power meter and the switch, and the system controller is configured to:
read a first time series having a first plurality of power signals and a second time series having a second plurality of power signals from the power meter, each power signal indicating of an amount of power recorded by the power meter;
determine from the first time series and the second time series a maximum series having a plurality of entries, wherein at least one entry is determined by applying a maximum function to a power signal of the first plurality of power signals and to a power signal of the second plurality of power signals;
determine a forecast series from the plurality of entries of the maximum series;
determine the load connection signal from the forecast series; and
communicate the load connection signal to the switch.

2. The power system according to claim 1, wherein:
the system controller comprises a memory storing a threshold quantity; and
the system controller:
reads the threshold quantity from the memory;
calculates a quantity from the forecast series, the calculated quantity selected from the group consisting of: a maximum value of the forecast series, a minimum value of the forecast series, a median value of the forecast series, and an average value of the forecast series;
compares the calculated quantity to the threshold quantity;
determines the load connection signal from the forecast series based on the comparison; and
communicates the load connection signal to the switch.

3. The power system according to claim 1, wherein:
the switch connects the power transmission bus to the load and disconnects the power transmission bus from the load; and
the power system comprises a power conversion module situated in the power transmission bus, the power conversion module configured to convert electric power originating from the energy conversion module into electric power suitable for the load.

4. The power system according to claim 1, wherein the power meter comprises the system controller.

5. The power system according to claim 1, wherein the system controller is configured to:
read a plurality of time series from the power meter, wherein each time series has a plurality of power signals indicating an amount of power recorded by the power meter;
determine from the plurality of time series an indexed series comprising at least one power signal from each time series; and
determine from the plurality of time series a maximum series having a plurality of entries, wherein at least one entry of the maximum series is a maximum value of the indexed series.

6. The power system according to claim 1, wherein the system controller is configured to:
read a plurality of time series from the power meter, wherein each time series has a plurality of power signals, each power signal indicating an amount of power recorded by the power meter;
determine from the plurality of time series a plurality of indexed series, every indexed series comprising at least one power signal from each time series; and
determine from the plurality of indexed series a maximum series having a plurality of entries, wherein every entry of the maximum series is a maximum value of one indexed series of the plurality of indexed series.

7. The power system according to claim 1, wherein the system controller is configured to:
receive a weather forecast signal; and
determine the forecast series as a function of the plurality of entries of the maximum series and as a function of the weather forecast signal.

8. The power system according to claim 7, wherein the system controller is configured to determine the forecast series as a function of the plurality of entries of the maximum series by modifying at least one entry of the maximum series as a function of the weather forecast signal.

9. The power system according to claim 7, wherein the system controller is configured to determine the forecast series as a function of the plurality of entries of the maximum series by modifying every entry of the maximum series as a function of the weather forecast signal.

10. The power system according to claim 1, wherein:
the power system comprises a temperature sensor; and
the system controller is in operative communication with the temperature sensor and is configured to:
read a temperature signal from the temperature sensor; and
determine the forecast series as a function of the plurality of entries of the maximum series and as a function of the temperature signal.

11. The power system according to claim 10, wherein the system controller is configured to determine the forecast series as a function of the plurality of entries of the maximum series by modifying at least one entry of the maximum series as a function of the temperature signal.

12. The power system according to claim 10, wherein the system controller is configured to determine the forecast series as a function of the plurality of entries of the maximum series by modifying every entry of the maximum series as a function of the temperature signal.

13. The power system according to claim 1, wherein the system controller is configured to communicate the forecast series to a remote controller using a digital communication protocol, the remote controller being located remotely from the power system.

14. A method for controlling a power system comprising a power meter, the method comprising:
receiving a weather forecast signal;
reading a plurality of time series from the power meter, wherein each time series has a plurality of power signals, each power signal indicating an amount of power recorded by the power meter;
determining from the plurality of time series a plurality of indexed series, every indexed series comprising at least one power signal from each time series;
determining from the plurality of time series a maximum series having a plurality of entries, wherein at least one entry of the maximum series is a maximum value of one indexed series of the plurality of indexed series;
determining a forecast series by modifying every entry of the maximum series as a function of the weather forecast signal;
determining a load connection signal from the forecast series; and
communicating the load connection signal to a switch.

15. A non-transitory, computer-readable medium containing a program, the program, when accessed and executed by a processor, causing the processor to:
receive a weather forecast signal;
read a plurality of time series from a power meter, wherein each time series has a plurality of power signals, each power signal indicating an amount of power recorded by the power meter;
determine from the plurality of time series a plurality of indexed series, every indexed series comprising at least one power signal from each time series;
determine from the plurality of time series a maximum series having a plurality of entries, wherein at least one entry of the maximum series is a maximum value of one indexed series of the plurality of indexed series;
determine a forecast series by modifying every entry of the maximum series as a function of the weather forecast signal;
determine a load connection signal from the forecast series; and
communicate the load connection signal to a switch.
